(19) United States
(12) Patent Application Publication
(10) Pub. No.: US 2005/0168986 A1
(43) Pub. Date: Aug. 4, 2005

(54) Reflector assemblies for luminaires

(76) Inventor: Scott Wegner, Peachtree City, GA (US)

Correspondence Address: CLARK & BRODY, 1090 VERMONT AVENUE, NW, SUITE 250, WASHINGTON, DC, 20005, US

(21) Appl. No.: 11/038,102

(22) Filed: Jan. 21, 2005

Related U.S. Application Data
(60) Provisional application No. 60/539,986, filed on Jan. 30, 2004.

(51) Int. Cl. F21S 4/00

(52) U.S. Cl. 362/241

(57) ABSTRACT

Downlighting luminaires equipped with particular light sources such as PAR lamps, light emitting diode (LED) arrays and the like, are equipped with reflectors that do not converge light rays incident thereon from the light source. Downlighting luminaires configured according to the invention reduce or eliminate undesirable beam striations on horizontal surfaces and “busy” scallops on vertical surfaces with improvement of reflector flash performance. Particular reflectors have divergent reflective surfaces or conical surfaces, the reflectors preferably being optically separated from a face of the lamp such as by means of a matte black annulus or “snoot” disposed between the lamp face and opposing edges of the reflector.

### BACKGROUND OF THE INVENTION

1. Field of the Invention

The invention relates generally to downlighting luminaires and, particularly, to such luminaires utilizing light sources such as PAR lamps, which produce unwanted beam striations and the like when used with conventional parabolic reflectors.

2. Description of the Prior Art

Downlighting luminaires are used in a wide variety of configurations for general lighting, task lighting, accent lighting, emergency lighting, and the like. By being recessed in a ceiling, or otherwise mounted such as in a wall or carried by a framework spaced from a true ceiling, downlighting luminaires are desirably unobtrusive. Downlighting luminaires are designed for use with a variety of light sources including incandescent, fluorescent, and high-intensity-discharge lamping, to list but a few. Quite often, a given environmental space is provided with downlighting luminaires having different light sources, and it is desirable for such luminaires to appear similar and perform within acceptable parameters. In particular, the nature and character of the beams directed onto surfaces within such a space by downlighting luminaires equipped with different light sources should be similar and free of unwanted. glare, striations and unattractive “scallops.” Lighting applications, such as general purpose lighting in mid-height ceilings, including school auditoriums, airports, civic centers, arenas, retail establishments, and shallow atrium spaces, are often amenable to the use of downlighting luminaires provided with lamps having a filament mounted with respect to a parabolic aluminized reflector (PAR) so that light from the filament is projected from the face of the “PAR” lamp. The face of such a PAR lamp is provided with a plurality of prism-like elements that spread the light reflected from the parabolic aluminized reflector of the lamp such that the light exiting the face of the lamp provides a smooth light pattern in the far field. Known lighting systems include the use of incandescent PAR lamps and high intensity-discharge (HID) PAR lamps. Such downlighting luminaires are also often used to accent specific architectural elements or portions of displays. It is generally desirable to reduce, or at least control unwanted glare, beam striations, and unsightly scalloping usually associated with downlighting luminaires that use PAR lamps as the light source. Applicants have determined that these undesirable features in the light pattern arise from the interaction between the near-field light pattern produced by the PAR lamp and the reflector of the luminaire. Thus, even if the PAR lamp has been designed to provide a smooth light pattern in the far field when used alone, its use with the optics of a luminaire has been found to produce undesirable features of the lighting pattern. Reduction or elimination of these features where luminaires using PAR lamps are employed by mounting in or on ceilings is particularly desirable.

Conventional downlighting luminaires overwhelmingly employ reflectors having parabolic reflective surfaces. Similar reflectors are used with other concave reflective surfaces. When used with PAR lamps, these reflectors usually produce undesirable beam striations on surfaces on which the beam is directly incident and even unattractive scalloping on laterally disposed surfaces. Also known in the art are downlighting luminaires using R-lamps as the light source in combination with frusto-conical reflectors. These luminaires are available from Juno Lighting, Inc. of Des Plaines, Ill. 60017, catalog Nos. TC 2-27 and SC 2-27, inter alia.

Light emitting diodes have been proposed for use in luminaires. U.S. Pat. No. 6,250,774 to Begemann et al. shows a luminaire where each LED, or group of LEDs, is provided with a conical reflector. The Begemann et al structure is not amenable to use in a downlighting environment, however. Marshall et al. (U.S. Pat. No. 6,200,002) suggest using light emitting diodes instead of a PAR lamp in a luminaire. Hubbard et al. (U.S. Pat. No. 4,228,485) show an LED in association with a conical reflector. Klein (U.S. Pat. No. 4,217,625) and Clark (U.S. Pat. No. 5,255,171) disclose concentrating optics wherein light emitting diodes are used in combination with an inverted conical reflector.

Downlighting luminaries, such as that provided by the invention,. must also be easily assembled, installed, and wired without the need for unusual tools and must also reduce the risk of cuts, abrasions, or other injuries to installers. Still further, downlighting luminaires as herein provided must be capable of being easily maintained by relatively inexperienced personnel, so that re-lamping and repair can be readily accomplished without the need for particular training. Components requiring maintenance, such as lamps, must be readily accessible, and conventional mounting hardware should be suitable for the luminaires herein disclosed.

The downlighting luminaires configured according to the present invention address the above requirements by utilizing reflective surfaces in combination with PAR lamps or an array of light emitting diodes to reduce or eliminate undesirable characteristics inherent in prior downlighting luminaires employing PAR lamps and the like. The invention thus provides a substantial advance in the art.

### SUMMARY OF THE INVENTION

Applicants have discovered that the conventional reflector used in a luminaire, which is concave and often parabolic, interacts with the near-field light pattern of a PAR lamp resulting in an undesirable light pattern in the far field. In accordance with the invention, several embodiments of an optical arrangement are provided that are particularly suited for downlighting applications, yet useful also in luminaires intended for other applications. In downlighting applications and particularly recessed downlighting applications, the optical arrangements of the invention take the form of a reflector that is preferably conical (i.e., a revolved straight line) but also divergent (i.e., a revolved convex curve), and used in concert with a PAR lamp or other lamp having a lenticular pattern, that is, a “dimpled” lens face or similar pattern. A particularly effective reflector is a conical reflector that takes the form of the frustum of a cone. Reflectors as thus described are preferably spaced from the PAR or similar lamp, the lens face of the lamp being separated from upper portions of the reflector by a gap preferably occupied by an annular element that is not reflective and is preferably black to absorb incident light. The annular element separates the lamp from the upper part of the reflector thereby to improve the performance of the optics of a luminaire so configured.

Luminaires configured according to the invention control the light emitted from the face of the lamp such that an observer will generally see the face of the lamp itself before, or simultaneous with, the image of the face of the lamp in the reflector of the luminaire. This is accomplished by vertically displacing the face of the lamp from the top of the reflector by a distance such that an observer's line of sight to the far edge of the lamp is preferably parallel (or within ±2°) to the reflected ray from the near edge of the lamp. The observer's line of sight is generally considered to be about 40°, when measured from the horizontal, and acceptable results may be obtained if the line of sight is considered to be within the range of about 30° to about 50°. Acceptable results may be obtained if the direction of the reflected ray from the near edge of the lamp converges with the line of sight by about 5° or diverges from it by about 10°.

In accordance with the invention, the luminaire reflector does not converge the light from the face of the lamp in the vertical plane. It has been discovered that the prior art systems having concave (particularly parabolic) reflectors create magnified virtual images of the spatially discernable features of the face of the lamp. These spatially discernable features are generally the prismatic elements provided on the output face of a PAR lamp that spread the projected light in the far field to smooth the light pattern. The interaction of the light from these elements with a converging reflector, however, prevents the desired mixing of the light in the far field. Mixing in the far field is prevented because the reflector creates a magnified virtual image of each element in the reflector, and the laws of optics require that the field of view of that element is necessarily smaller. The light from the individual elements on the face of the PAR lamp, therefore, do not mix properly in the far field because the field of view of each element is too small to overlap appropriately with the light from the other elements.

This invention contemplates the use of reflective surfaces used in combination with a PAR or similar lamps whereby the reflective surfaces cause light rays incident thereon not to converge as occurs with concave reflective surfaces such as parabolic surfaces as are commonly employed in downlighting and other applications, such parabolic surfaces essentially providing magnified virtual images of the spatial elements of the incident light pattern. A particular reflector useful according to the invention is referred to herein for simplicity as a “conical” reflector, such a reflector having reflective surfaces in the shape of a frustum of a cone. Luminaires utilizing PAR lamps, or similar lamps, find particular utility through incorporation of reflectors having neutral or diverging reflective surfaces to include convex and conical reflectors according to the invention, such luminaires providing improved light patterns whether the lamping employed takes the form of incandescent or HID versions of PAR lamping such as PAR 20, 30 and 38 lamps. It is to be understood that neutral or diverging convex reflectors (or under appropriate circumstances a concave diverging reflector) can also be employed according to the invention and are encompassed within the definition of neutral or diverging reflectors as defined herein. Combinations including a matte, black annulus, such as in the form of a snoot, with a divergent or conical reflector and a PAR lamp results in luminaires such as downlighting luminaires that substantially improve the characteristics of light emanating from such luminaires through glare reduction, reduction or elimination of striations, and improvement of the appearance of scallops apparent on surfaces of an environmental space with which such luminaires are used. The annulus not only separates the reflector and the lamp physically but also improves reflector flash performance and produces a more clear projected beam: It is also to be understood that the use of the terms “divergent reflective surfaces”; “diverging reflective surfaces”; a “divergent reflector” or a “diverging reflector” encompasses a conical reflector or conical reflecting surfaces as well as convex and other surfaces that are substantially diverging with respect to their reflection of incident light rays.

Another embodiment of the invention uses a plurality of light emitting diodes as the light source, an optical arrangement of this LED embodiment mixing the light from an array of light emitting diodes, which may be a circular array, hexagonal array, or square array, among others. Such an array of light emitting diodes behaves similarly to a PAR lamp in that dark patches between adjacent light emitting diodes produce a beam pattern similar to that produced by the internal reflective surfaces and prismatic lens of a PAR lamp. A divergent or conical reflector used with an LED array mixes light from the plurality of light emitting diodes to yield a beam having a minimum of imperfections, such as striations and the like, and which therefore finds practical utility in lighting applications. A gap between the LED array and facing portions of the reflector configured according to the invention is preferably occupied by a band-like annular element preferably provided with a matte, black finish.

The invention contemplates application in luminaires other than downlighting luminaires. In addition to recessed, wall-mounted luminaires as well as surface-mounted wall and ceiling-mounted luminaires, the optical arrangements of the invention find application in any luminaire wherein performance can be improved by formation of a beam characterized by a reduction or elimination of striations projected onto surfaces illuminated by such luminaires. A reduction or elimination of striations in a beam emanating from a luminaire improves the luminaire through realization of more useful illumination occurring by virtue of the absence of distractions caused by glare, striations and the like resulting from or seen in such a beam. Accordingly, any light source including a PAR or similar lamp that produces in combination with a conventional concave reflector, such as a parabolic reflector, an undesirable glare and/or distracting striations on surfaces illuminated by such a beam is suitable for use in the present concepts. The optical arrangement disclosed herein thus finds application in other than downlighting luminaires, the invention being described herein previously relative to downlighting luminaires due to particular utility in such luminaires and also for the sake of ease of description.

Accordingly, it is an object of the invention to provide luminaires utilizing light sources such as PAR lamps or the like that are configured with a divergent or conical reflector preferably spaced from a lens face of such a light source to form a gap therebetween, the gap being preferably occupied by a band-like annulus element preferably having an absorptive finish of a relatively dark coloration such as black.

It is another object of the invention to provide a luminaire having a LED array as the light source, the LED array being a portion of an optical arrangement that also includes a divergent or conical reflector preferably spaced from the LED array with a resulting gap therebetween preferably being occupied by a band-like annular element preferably provided with a matte finish of a relatively dark coloration such as black.

It is a further object of the invention to provide downlighting luminaires utilizing light sources such as PAR lamps and the like that are configured with a divergent or conical reflector preferably spaced from lens faces of such light sources, gaps thus formed therebetween that are each preferably occupied by a band-like annular element preferably having a matte finish of relatively dark coloration such as black, the downlighting luminaires thus configured preferably being recessed in ceilings or walls of environmental spaces and producing beams of improved quality characterized by reduction or elimination of striations on surfaces of such spaces illuminated by such beams.

Further objects and advantages of the invention will become more readily apparent in light of the following detailed description of the preferred embodiments.

### BRIEF DESCRIPTION OF THE DRAWINGS

FIG. 1 is a side elevational view in partial section of a prior art downlighting luminaire having an R lamp as a light source and a reflector formed as a frustum of a cone;

FIGS. 2A through 2E are schematics illustrating the virtual images seen in the reflector of a prior art combination of a PAR lamp with a parabolic reflector as is normally employed in downlighting applications;

FIG. 3A is a schematic conceptually illustrating a vertical cross section of a downlighting luminaire configured according to the invention and having a PAR lamp in combination with a divergent reflector;

FIGS. 3B through 3F are schematics illustrating the virtual images seen in the reflector of the combination illustrated in FIG. 3A;

FIG. 4A is a schematic conceptually illustrating a downlighting luminaire configured according to an embodiment of the invention and having a PAR lamp in combination with a conical reflector;

FIGS. 4B through 4F are schematics illustrating the virtual images seen in the reflector of the combination illustrated in FIG. 4A;

FIG. 5A is a perspective view of a downlighting luminaire configured according to an embodiment of the invention with a particular PAR lamp and a conical reflector;

FIG. 5B is a vertical cross-section of the luminaire of FIG. 5A;

FIG. 6A is a perspective view of a downlighting luminaire configured according to another embodiment of the invention with a PAR lamp and a conical reflector;

FIG. 6B is a vertical cross-section of the luminaire of FIG. 6A;

FIG. 7A is a perspective view of a downlighting luminaire configured according to a further embodiment of the invention with a PAR lamp and a conical reflector;

FIG. 7B is a vertical cross-section of the luminaire of FIG. 7A;

FIG. 8A is a perspective view of a downlighting luminaire configured according to a further embodiment of the invention with a PAR lamp and a conical reflector;

FIG. 8B is a vertical cross-section of the luminaire of FIG. 8A;

FIG. 9A is a perspective view of a downlighting luminaire configured according to yet another embodiment of the invention with a PAR lamp and a conical reflector;

FIG. 9B is a vertical cross-section of the luminaire of FIG. 9A;

FIG. 10A is a perspective view of a downlighting luminaire configured according to a further embodiment of the invention with a particular PAR lamp and a conical reflector;

FIG. 10B is a vertical cross-section of the luminaire of FIG. 10A;

FIG. 11A is a perspective view of a downlighting luminaire configured according to a particular embodiment of the invention with an array of light emitting diodes and a conical reflector; and,

FIG. 11B is a vertical cross-section of the luminaire of FIG. 11A.

### DESCRIPTION OF THE PREFERRED EMBODIMENTS

Referring now to the drawings and particularly to FIG. 1, a prior art downlighting luminaire 10 includes a housing 12 within which an R30 lamp 14 is mounted by a socket 16. A reflector 18 having reflective surfaces 20 is formed as a frustum of a cone. Lower portions of the lamp 14 extend below the top of the reflector and into the space within the reflector 18 through open upper portions of reflector 18. Lens face 22 of the lamp 14, thus, lies substantially within the space defined by the reflector 18 and is below the upper edges of the reflector 18. The downlighting luminaire 10 is usually mounted in a recessed location within a ceiling or the like (not shown) by a conventional mounting frame shown generally at 24. The luminaire 10 is seen to utilize a conically shaped reflector 18 in combination with an R lamp. Because the R lamp has a diffuse coating on exit face 22, the light pattern is generally uniform in the near field and does not give rise to the non-uniformities inherent in a PAR lamp. Thus, luminaire 10 does not provide the teachings herein detailed relative to improvement of beam characteristics occurring in the use of PAR lamps and the like with conventional reflectors such as parabolic reflectors and particularly in downlighting applications.

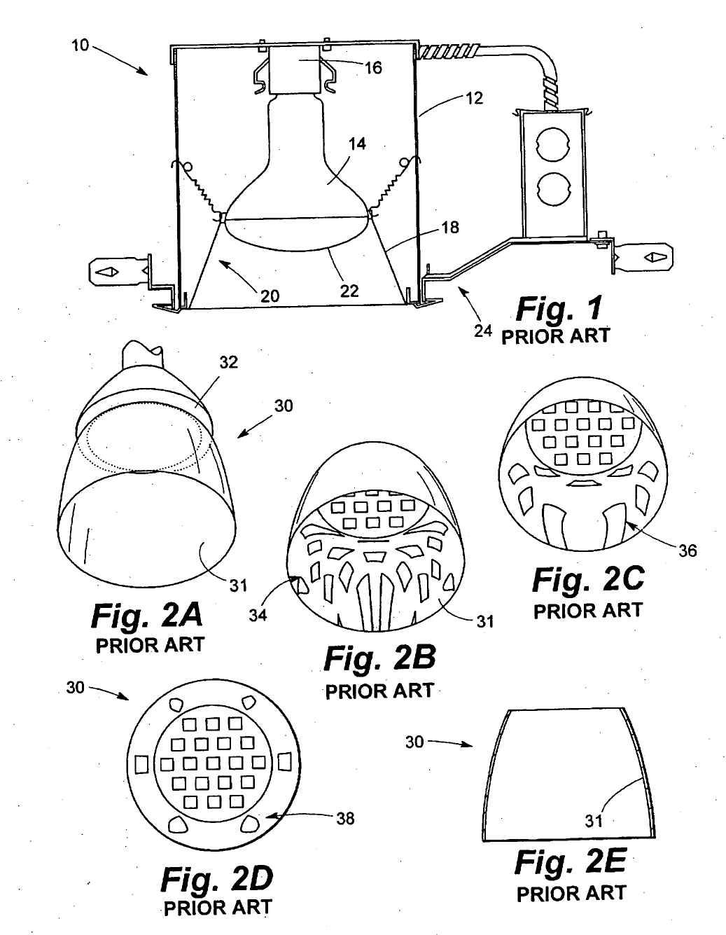

Referring now to FIGS. 2A through 2E, a prior art parabolic reflector is seen at 30 in schematic representations in combination with a PAR lamp represented at 32. The PAR lamp 32 is closely adjacent the upper portion of the parabolic reflector 30. The combination of a parabolic reflector such as the reflector 30 and a light source such as the PAR lamp 32 is commonly employed in the prior art for use in downlighting applications. Such combinations typically create striations in the projected light beam. A major cause of the striations and unattractive scalloping is that the converging, generally parabolic reflector 30 interacts with the near field pattern of the PAR lamp to create magnified virtual images of the element of the spatial pattern on the face of the PAR lamp. This causes the reflected images seen by a person in the illuminated space on the concave reflective surfaces of the parabolic reflector 30 to appear overly large, distorted, separated and sparse as can be appreciated from the schematic representations of FIGS. 2B through 2D. These reflected images are commonly referred to as “flash.” Unsightly striations also occur in the beam incident, particularly, on horizontal surfaces within a space illuminated by a downlighting luminaire configured with the parabolic reflector 30 and the PAR lamp 32, and unattractive scalloping occurs on vertical surfaces, such as walls.

The luminaire shown in FIGS. 2A through 2D provides a shield angle of 40° from the horizontal, which is the commonly accepted angle at which a person in the illuminated space views recessed luminaries of this type. The schematic of FIG. 2A illustrates the situation where no visible flash is seen by an observer. The schematic of FIG. 2B illustrates the luminaire when viewed at an angle of 42°. Here, the reflector produces images of the near field light pattern as illustrated at 34. These images appear as virtual images on or behind the concave reflective surface of the parabolic reflector 30. These images are illustrated representationally and are not necessarily square or shaped or sized as expressly shown in the drawing figures. The schematic of FIG. 2C illustrates the luminaire when viewed at an angle of 65° from the horizontal. The concave reflective surface of the parabolic reflector 30 creates images 36 illustrated in FIG. 2C. FIG. 2D schematically illustrates flash performance essentially at 90°, the images being illustrated at 38.

The flash performance illustrated varies and depends on such factors as the dimensions of the reflector apertures, the dimensions of the lamp, the lenticular pattern of the lamp, and others. The parabolic profile of the reflector 30 is further to be appreciated from consideration of external contours of the reflector 30 as seen in FIG. 2E, the contours of the reflective surfaces of the parabolic reflector 30 being traditional in downlighting luminaire applications within which large light sources, such as horizontal compact fluorescent lamps (not shown) are used, such contours producing wide distributions as well as top-down flash (i.e., the images of the lamp in the reflector move downward) and lamp-before-lamp-image performance (i.e., the viewer sees the lamp itself before seeing images of the lamp in the reflector).

The conventional luminaire having a parabolic reflector focuses light in two dimensions, and the result, when the light source is a PAR lamp, is the projection of swirling striations on an illuminated horizontal surface, such as a floor. Luminous halos outside of the main beam are also produced by a parabolic reflector in combination with PAR lamps, thereby causing thin, bright scallops to be produced on illuminated walls. Prior art luminaries of the type improved by application of the principles of the invention do not produce spatially uniform patterns.

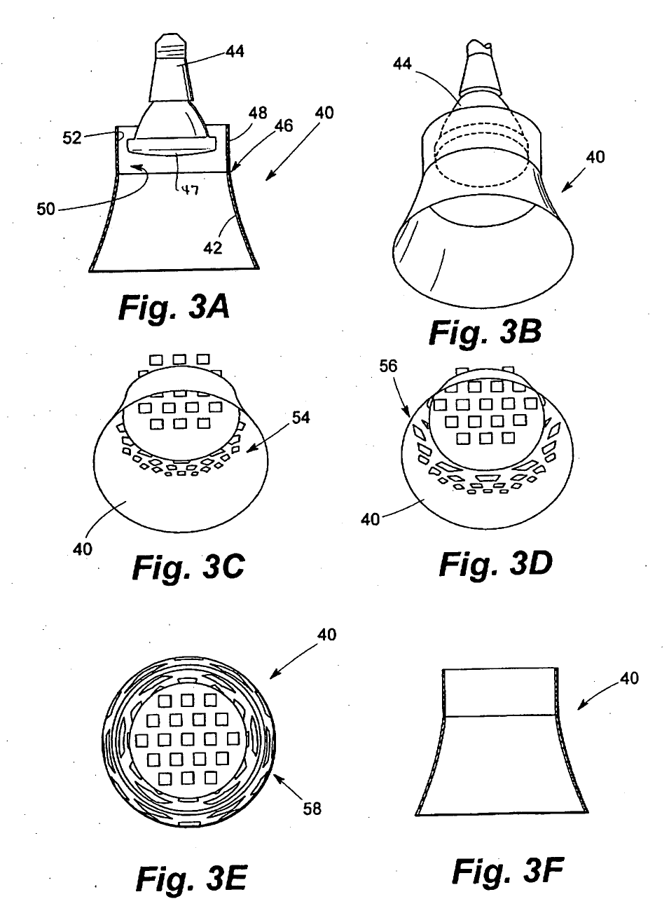

FIG. 3A illustrates a luminaire according to the invention and includes, a reflector 40 that includes a diverging reflective surface 42 and a lamp 44, which is in the form of a PAR lamp or a lamp having similar characteristics as discussed herein. The reflective surface 42 is convex to the longitudinal axis of the reflector, rather than concave as is the parabolic surface of the prior art reflector 30. The convex curvature diverges incident light from the lamp whereby the virtual images of the elements of the lamp pattern are reduced in size. In accordance with the principles of optics, the angle of view of these images is larger, and the patterns thereby overlap in the far field to provide a more even illumination. The diverging property, however, generally precludes the desired lamp-before-lamp-image features when the face of the PAR lamp is placed at the top of the curved reflector.

Applicants have discovered that lamp-before-lamp-image can be provided with a diverging reflector by locating the face 47 of the PAR lamp above the top 46 of the reflector 40. An annulus element 48 is preferably provided to occupy gap 50 between the reflector 40 and the lamp face 47. The annulus element 48 is band-like, and the internal surface 52 preferably has a matte finish and a light-absorbing color, preferably black. This ensures that unwanted light is absorbed and neither escapes between the lamp and reflector nor impinges on the reflective surface 42. A structure similar to the annulus element 48 has existed in the art and has been often referred to as a “snoot.” However, snoots of the prior art have not been used in the optical combinations disclosed herein and have not functioned similarly. In part, the annulus element 48 facilitates placement of the face of the lamp 44 with respect to the reflector 40 so that the desired characteristic of “lamp-before-lamp-image” may be obtained.

Referring now to FIGS. 3B through 3F, it can be appreciated that the convex profile of the diverging reflective surface 42 causes incident light rays to diverge from one another rather than to converge as occurs with a reflector such as the parabolic reflector 30 of FIG. 2A, as an example. This divergence diminishes the striated effect that is caused by the parabolic reflector 30 of FIG. 2A when used in combination with a lamp such as the PAR lamp 32 in the prior art combination shown. The effect produced through use of the divergent reflector 40 is seen in FIGS. 3B through 3D with it being noted that the shield angle is 40° to the lamp 44. FIG. 3B schematically shows no visible flash image, as would be expected at an observational angle of 40°. from the horizontal. FIG. 3C schematically illustrates images at 54, which are seen on the reflective surface 42 of the divergent reflector 40. FIG. 3D illustrates the images 56 that are visible at an angle of 65°. FIG. 3E schematically illustrates at 58 the flash performance viewed from 90°. It is to be understood that the locations, sizes, and other characteristics of the reflector flash images represented in FIGS. 3C through 3E vary depending on reflector aperture and lamp wattage, inter alia. Nevertheless, the general comparison between the images illustrated in FIGS. 3C through 3E and those shown in FIGS. 2B through 2D are representative. The divergent profile of the reflector 40 is further to be appreciated from consideration of external contours of the reflector 40 as seen in FIG. 3F.

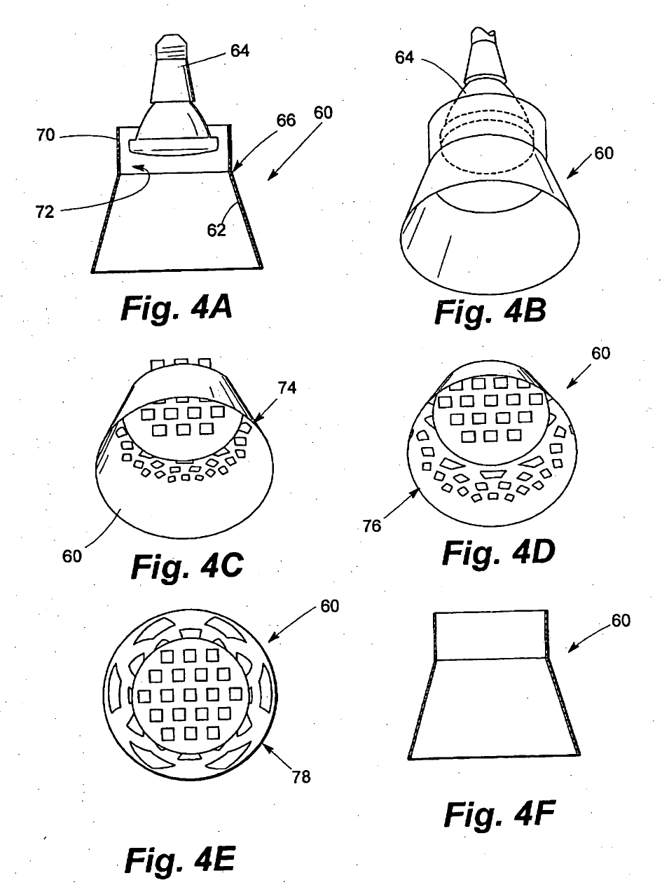

Referring now to FIG. 4A, a reflector 60 is seen to have a conical reflective surface 62 that is spaced from a lamp 64 in the form of a PAR lamp or a lamp having similar characteristics as discussed herein. The reflective surface 62 is essentially straight in section as illustrated in FIG. 4A and is formed by revolving a straight line about the longitudinal axis of the reflector. The conical nature of the reflective surfaces 62, that is, the conical reflector shaped as a frustum of a cone, also requires the lens face 68 to be spaced from the top edge 66 of the reflector 60 to achieve the desired flash characteristics. An annulus element 70 is also preferably provided to occupy gap 72 between the reflector 60 and the lamp 64, the annulus element 70 being configured essentially as the annulus element 48 described hereinabove. The profile of the conical reflective surfaces 62 is a simple shape that curves only in one dimension (i.e., that perpendicular to the plane of the figure) yet because it does not converge, it requires the use of an annular element to get the desired flash characteristics, such as the annulus element 70 through a smaller element than is required for use with the divergent reflector 40. The gap 72 is thus seen to be effectively smaller than the gap 50 of the arrangement seen in FIG. 3A.

Referring also now to FIGS. 4B through 4F, it is seen that the conical profile of the reflective surfaces 62 focuses light rays in only one dimension, thereby effectively minimizing distortion on said surfaces 62 relative to the distortions that would be produced by the parabolic contours of the prior art reflector 30 of FIG. 2A. The conical profile further images a multiplicity of lenticular lens elements of the PAR lamp 64 to a greater degree than occurs with parabolic reflective surfaces or reflective surfaces of a non-divergent nature. By imaging more of the lenticular lens elements, the individual distributions of the lens elements are mixed together more effectively to produce the results intended by the invention. Use of the conical reflector 60 with the PAR lamp 64 particularly in combination with the annulus element 70 effectively eliminates halos so that a downlighting luminaire configured with an optical arrangement as described herein smoothly illuminates wall surfaces (not shown) and the like within an environmental space illuminated by such a luminaire. The effect produced through use of the conical reflector 60 is seen in FIGS. 4B through 4D with the shield angle being taken to be 40° to the lamp 64. FIG. 4B schematically shows no visible flash image as would be expected at an observational angle of 40°. FIG. 4C schematically illustrates an image at 74 seen on the conical surfaces 62 of the reflector 60 at an angle of 42°. An angle of 65° from nadir produces an image at 76 on said conical surfaces 62 as is representationally seen in FIG. 4D. FIG. 4E schematically illustrates flash performance essentially at nadir as seen at 78. It is to be understood that the flash images represented in FIGS. 4C through 4E have locations and characteristics that vary depending on reflector aperture dimensions, lamp wattage and lenticular lens pattern inter alia. The conical profile of the reflector 60 is further to be appreciated from consideration of external contours of the reflector 40 as seen in FIG. 4F. As with the FIGS. 3B through 3F, the FIGS. 4B through 4F are realized with a disposition of the respective lamps represented at 44 and 64 directly above and spaced from the reflectors 40 and 60.

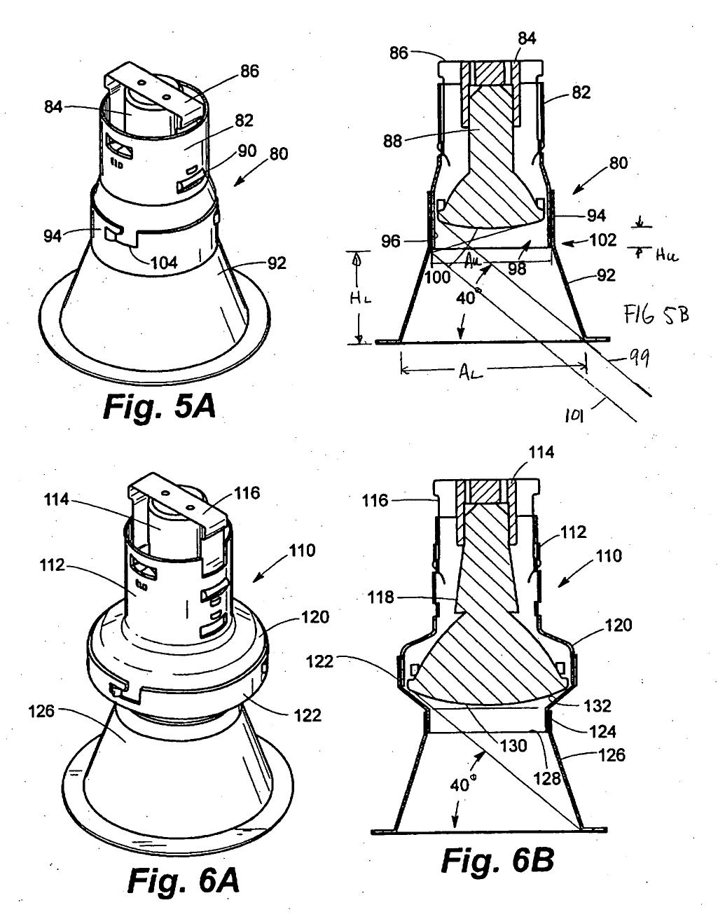

Referring now to FIGS. 5A and 5B, a downlighting luminaire 80 is seen to have a housing 82 mounting a lamp socket 84 by means of a spring clip 86, as is conventional in the art. The lamp socket 84 conventionally mounts a PAR lamp 88 that takes the form in this embodiment of a PAR 20 lamp. The housing 82 is provided with locator slots 90 that receive portions of the spring clip 86 to position the lamp 88 properly within the luminaire 80. A conical reflector 92 having a cylindrical sleeve 94 mounts to the housing 82 at lower portions 96, which essentially form an annular element occupying the gap 98 between lens face 100 of the PAR 20 lamp 88 and peripheral top edges of the conical reflector seen at 102. The annular element 96 is band-like and is preferably provided on its interior surfaces with a matte finish of a dark color, preferably black, for absorbing stray light.

A bayonet twist-lock slot 104 permits mounting the luminaire 80 to a mounting device (not shown) of conventional structure used to mount the luminaire 80 in a recessed location in a ceiling or the like. Interior reflective surfaces of the conical reflector 92 are preferably formed of anodized aluminum, and the luminaire 80 is configured as shown to have a shield angle of 40°.

The preferred construction of a luminaire in accordance with the principles of the invention is illustrated in FIG. 5B. The preferred shield angle of 40° arises from the generally accepted observation that this is at the edge of or just outside of the view of a viewer who is looking generally forward (i.e., not upward or downward). To obtain the desirable feature of “lamp-before-lamp-image,” the viewer must first see the lamp itself and then see the image of the lamp. Light rays 99 and 101 illustrate these properties. The position of ray 99 with respect to ray 101 illustrates the property of “lamp-before-lamp-image” because the viewer approaching from the right of the figure will first see ray 99, which is a ray from the far end of the face of lamp 88 that is seen directly (i.e., without reflection). The viewer then sees ray 101, which is a reflected image of the near end of the face of the lamp. As the viewer moves from right to left of. FIG. 5B, the image of the face of the lamp will move downward with respect to the reflector 92 to provide “top-down flash.”

The features shown in FIG. 5B are achieved by placing the face of the lamp above the top of the reflector by a distance shown as H_{U}. This distance is that for which a ray, illustrated as ray 99, coming directly from the lamp will just clear the bottom of the reflector and be seen by the viewer at the intended shield angle. The specific magnitude of H_{U} depends upon the diameter of the face of the lamp, the size of the upper (input) aperture A_{U} of the reflector, the size of the lower (output) aperture A_{L} of the reflector, and the height H_{L} of the reflector. It will be understood that the parameters A_{U}, A_{L}, and H_{L} also depend on the angle of the reflector 92 so that this angle is taken into account in these parameters. The geometry of FIG. 5B cannot generally be obtained with a neutral or diverging reflector unless the face of the lamp is above the top of the reflector by the distance H_{U} that provides the geometry shown in FIG. 5B.

While the preferred shield angle is 40°, the principles of the invention apply to a shield angle of from about 30° to about 50°. Also, while the preferred embodiment is where the ray 101 is parallel to ray 99, it is within the scope of the invention for the ray 101 to converge toward ray 99 by about 5° or diverge from ray 99 by about 10°.

Referring now to FIGS. 6A and 6B, a downlighting luminaire 110 similar in structure and function to the luminaire 80 of FIGS. 5A and 5B is seen to have a housing 112 suitable for mounting a lamp socket 114 by means of spring clip 116, a PAR lamp 118 being mounted by the lamp socket 114. The lamp 118 is a PAR 30 long lamp in this embodiment of the invention, accommodation of the dimension and shape of the lamp 118 requiring a bulbous lower portion 120 to be formed in the housing 112, said lower portion 120 mating with an adapter 122 of similar, congruent shape to further mount at lower portions of said adaptor 122 to a cylindrical sleeve 124 terminating a conical reflector 126 at upper peripheral edges 128 of said reflector. Lens face 130 of the lamp 118 is spaced from the upper edges 128 of the conical reflector 126 through the agency of the adapter 122, inner wall surfaces 132 of the adapter 122 preferably having a matte finish and being painted a dark coloration such as black, lower portions of the wall surface 132 functioning as an annulus element as thus described. It is to be understood that interior wall surfaces of the lower portion 120 of the housing 112 are preferably finished similarly to that finish provided on the wall surface 132.

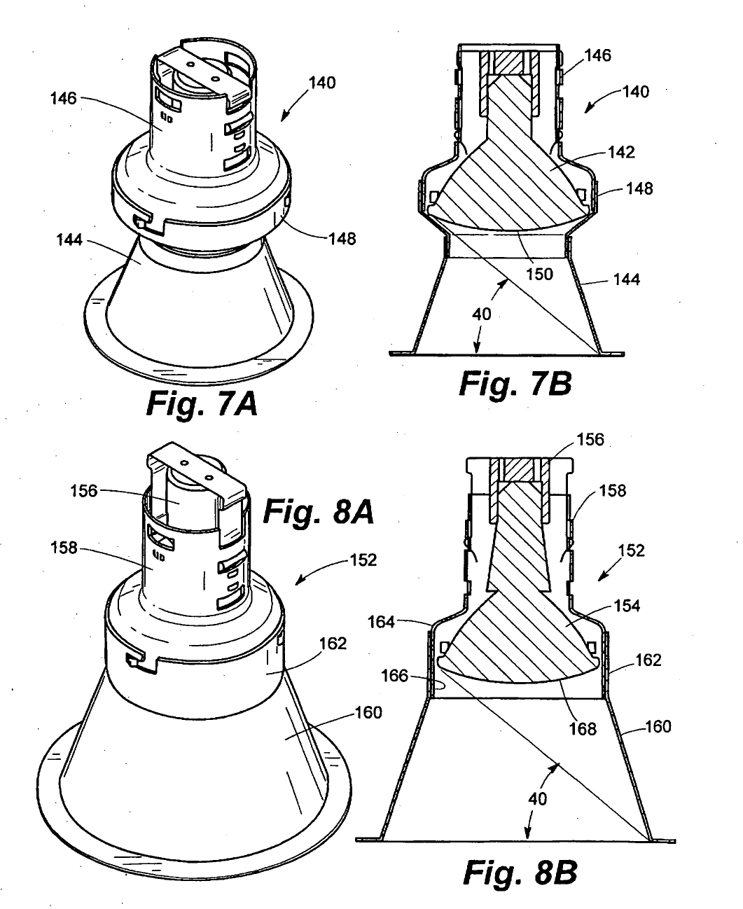

As can be seen in FIGS. 7A and 7B, a downlighting luminaire 140 configured similarly to the luminaire 110 is seen to employ a PAR 30 short lamp 142 in combination with a conical reflector 144. The dimensions and shape of the lamp 142 causes a housing 146 and an adaptor 148 to be configured as shown as to shape and dimensions in order to space upper edges of the reflector 144 from the lamp 142 with lower portions of the adapter 148 being painted a matte black finish in order to occupy a gap between lens face 150 of the lamp 142 and upper peripheral edges of the reflector 144.

FIGS. 8A and 8B illustrate a further embodiment of the invention that takes the form of a downlighting luminaire 152 having a PAR 30 long lamp 154 mounted by a lamp socket 156 within a housing 158. The housing 158 mounts a conical reflector 160 through fitting of a cylindrical sleeve 162 of the reflector 160 within enlarged cylindrical lower portion 164 of the housing 158, inner wall surfaces 166 of the lower portions 164 being painted a matte black so as to function as an annulus element as described herein. As with the other embodiments of the invention shown herein, lens face 168 of the lamp 154 is spaced from peripheral upper edges of the reflector 160.

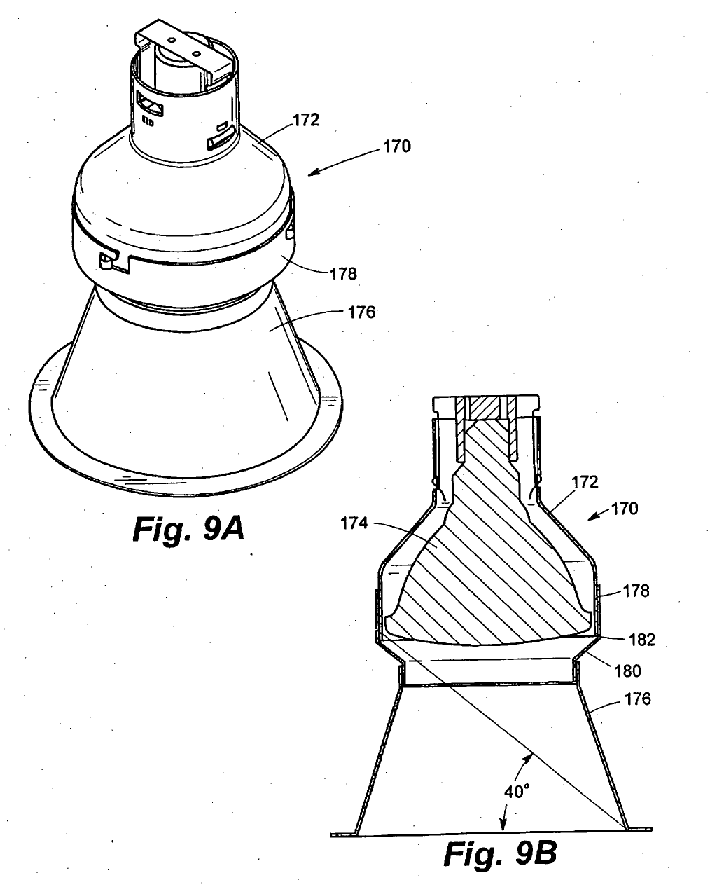

FIGS. 9A and 9B illustrate yet another embodiment of the invention that takes the form of a downlighting luminaire 170 having a housing 172 within which a PAR 38 lamp 174 is mounted in spaced relation to peripheral upper edges of a conical reflector 176. The housing 172 mates with an adapter 178 to form an enclosure of sufficient size and shape to accommodate the dimensions and shape of the lamp 174, interior surfaces of lower portions 180 of the adapter as well as interior surfaces of lower portions 182 of the housing 172 being finished with a black coloration to provide the function of an annulus element as disclosed herein.

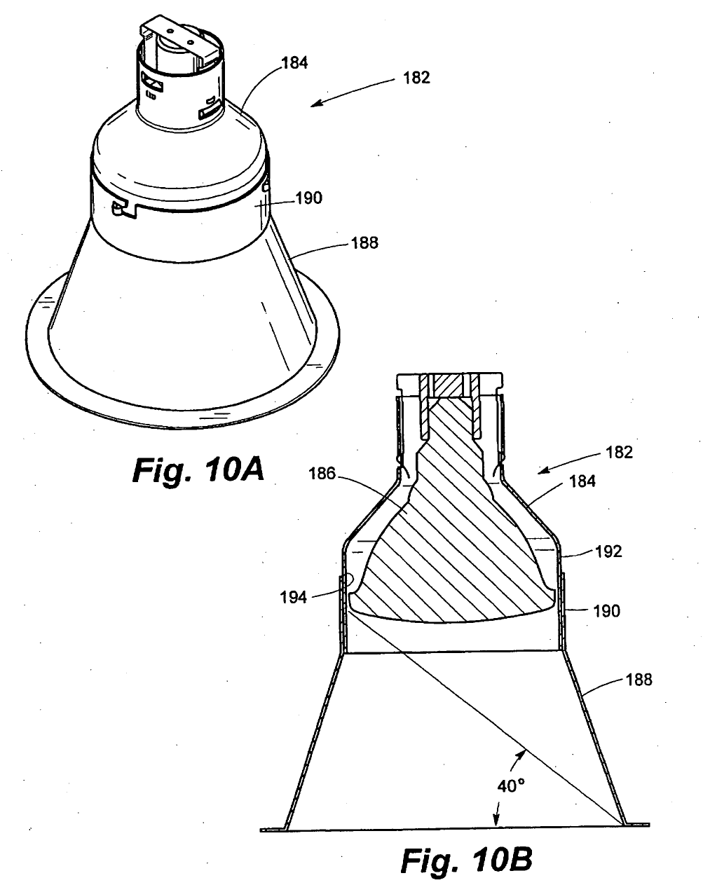

FIGS. 10A and 10B show a downlighting luminaire 182 formed of a housing 184 within which a PAR 38 lamp 186 is mounted in spaced relation to upper edges of a conical reflector 188, the reflector 188 having a cylindrical sleeve 190 integrally formed therewith which fits over a lower enlarged portion 192 of the housing 184. Surfaces 194 of the lower elongated portion 192 are painted black to function as an annulus element as described herein. The lower portion 192 of the housing 184 is enlarged relative to upper portions of the housing 184 to accommodate the shape and dimensions of the lamp 186. It is to be noted that the lamps employed in the luminaires disclosed hereinabove preferably take the form of incandescent or high intensity discharge PAR 20, 203 and 38 lamps, luminaires employing such lamps being configurable as disclosed for purposes of example as shown herein and as can be inferred therefrom.

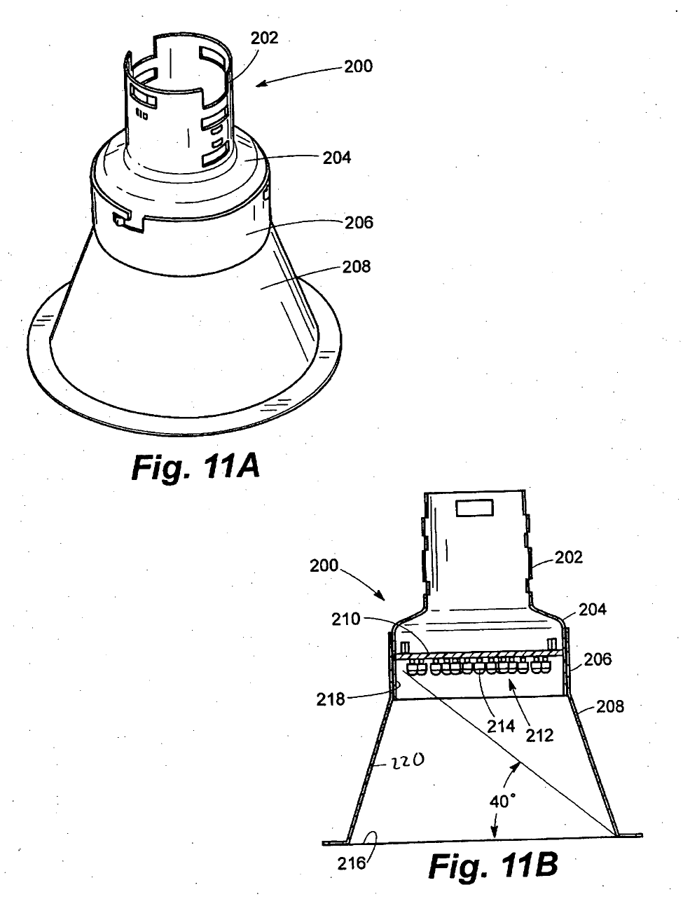

Referring now to FIGS. 11A and 11B, a downlighting luminaire 200 is seen to be formed of a housing 202 having an enlarged lower portion 204, the housing 202 conventionally taking the form of a housing useful for mounting PAR lamps as disclosed herein and without modification of the housing 202 for the purpose now described. The housing 202 mounts to a cylindrical sleeve 206 formed integrally with a conical reflector 208 by fitting of the sleeve 206 over the portion 204 of the housing 202. A substrate 210 disposed within the portion 204 of the housing 202 in spaced relation to upper peripheral edges of the reflector 208 mounts an array 212 of light emitting diodes 214 such as in concentric circles and other patterns with the diodes 214 pointing downwardly to direct light through aperture 216 of the reflector 208. Inner wall surfaces 218 of the housing 202 are painted a black coloration and function as an annulus element as disclosed herein, the dark colored surfaces 218 being disposed in a gap between the LED array 212 and peripheral upper edges of the reflector 208. Conical reflective surfaces 220 function to diverge light incident thereon from the LED array 212 and act to mix the light reflected therefrom to yield relatively even illumination of surfaces within a space being illuminated by the luminaire 200, striations in the resulting beam being reduced or eliminated in the same manner as with the several embodiments of the invention utilizing PAR lamps as light sources.

It is also contemplated that a diffuser or prismatic face similar to that used in a PAR lamp may be employed in combination with the LED sources.

It is to be understood that luminaires and the like can be configured according to the teachings of the invention other than as explicitly shown and described herein, the scope of the invention being defined by the appended claims.

1. A luminaire, comprising:
socket means for mounting a light source, and
a reflector comprising a reflective surface having an input aperture and an output aperture and arranged to receive light from said light source through said input aperture and to reflect said light through said output aperture without converging said light, wherein said socket is displaced from said input aperture away from said output aperture by a distance such that said luminaire provides top-down flash and lamp-before-lamp-image when said luminaire is arranged to project downward and is viewed from an angle of about 30° to about 50°.

2. The luminaire of claim 1 wherein the light source comprises a PAR lamp.

3. The luminaire of claim 1 wherein the light source comprises an array of light emitting diodes.

4. The luminaire of claim 1 wherein said reflective surface is frusto-conical.

5. The luminaire of claim 1 wherein said reflective surface is convex.

6. The luminaire of claim 1 wherein the luminaire comprises a downlighting luminaire.

7. The luminaire of claim 6 wherein the light source comprises a PAR lamp.

8. The luminaire of claim 6 wherein the light source comprises an array of light emitting diodes

9. The luminaire of claim 1 and further comprising: means for optically separating the light source from the reflector by said distance.

10. The luminaire of claim 9 wherein the separating means comprises an annular band disposed within a gap between the light source and the reflector.

11. The luminaire of claim 10 wherein interior surfaces of the annular band have a matte finish of a relatively dark coloration.

12. The luminaire of claim 10 wherein the light source comprises a PAR lamp.

13. The luminaire of claim 10 wherein the light source comprises an array of light emitting diodes.

14. A luminaire, comprising:
a housing adapted to receive a PAR lamp; and,
a reflector mounted by said housing in spaced relation to said lamp and defining a gap therebtween, said reflector receiving light from said lamp through an input aperture and reflecting said light through said output aperture such that when viewed at a shield angle of about 30° to about 50° a viewer sees light directly from said lamp before seeing light from said lamp reflected by said reflector.

15. The luminaire of claim 14 and further comprising means disposed between the lamp and the reflector for optically separating the lamp from the reflector.

16. The luminaire of claim 14 wherein the reflector comprises a conical reflector.

17. The luminaire of claim 15 and further comprising means disposed between the lamp and the conical reflector for optically separating the lamp from the conical reflector.

18. The luminaire of claim 16 wherein the separating means comprise an annular band disposed within a gap between the lamp and the reflector means.

19. The luminaire of claim 17 wherein the reflector means comprises a conical reflector.

20. A luminaire, comprising:
a housing;
an array of light emitting diodes mounted by the housing;
means carried by the housing for mixing the light generated by the light emitting diodes to form a beam free of striations.

21. The luminaire of claim 20 wherein the mixing means comprise:
a reflector spaced from the array and having non-converging reflective surfaces on which light generated by the array is incident.

22. The luminaire of claim 21 wherein the reflector is a conical reflector.

23. The luminaire of claim 21 wherein the mixing means further comprise: means disposed within a gap between the array and the reflector for optically separating the array from the reflector.

24. The luminaire of claim 22 wherein the reflector is a conical reflector.

25. A method for reducing striations in a beam produced by a light source comprising:
mounting the light source in spaced relation to a reflector having non-converging reflective surfaces on which light generated by the light source is incident; and,
optically separating the light source from the upper edge of said reflector.

26. The method of claim 25 and further comprising the step of physically separating the light source from the reflector.

27. The method of claim 25 wherein the reflector comprises a conical reflector.

28. The method of claim 25 wherein the light source comprises a PAR lamp.

29. The method of claim. 28 wherein the reflector comprises a conical reflector.

30. The method for claim 25 wherein the light source comprises an array of light emitting diodes.

31. A luminaire comprising:
means for mounting a lamp,
a reflector comprising a rotationally symmetric reflecting surface having an input aperture and an output aperture and mounted to receive light rays from said lamp through said input aperture and to reflect said light through said output aperture without converging said rays, and wherein said reflector is positioned with respect to said means for mounting such that light rays directly from said lamp passing through said output aperture form a predetermined angle with respect to the plane of said output aperture or larger angle, and wherein said predetermined angle is in the range of from about 30° to about 50°.
